(19) United States
(12) Patent Application Publication
(10) Pub. No.: US 2006/0077928 A1
(43) Pub. Date: Apr. 13, 2006

(54) Communication apparatus

(75) Inventor: Yoshihisa Amano, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/226,369

(22) Filed: Sep. 15, 2005

(30) Foreign Application Priority Data
Sep. 21, 2004 (JP) 2004-273380

(51) Int. Cl. H04Q 7/00

(52) U.S. Cl. 370/329

(57) ABSTRACT

In a communication apparatus adopting a MIMO transmission scheme and including M systems (where M is an integer equal to or greater than 2) of transmission circuits and N systems (where N is an integer equal to or greater than 2) of reception circuits, when handover from a first communication channel to a second communication channel takes place during communication of information, part of the transmission circuits and reception circuits are allocated for the establishment of the second communication channel and the rest of transmission circuits and reception circuits are allocated for the retaining of the first communication channel to continue the communication of information.

This nonprovisional application claims priority under 35 U.S.C. § 119(a) on Patent Application No. 2004-273380 filed in Japan on Sep. 21, 2004, the entire contents of which are hereby incorporated by reference.

### BACKGROUND OF THE INVENTION

1. Field of the Invention

The present invention relates to a communication apparatus that operates on a wired or wireless basis, and more particularly to a wireless communication apparatus that conducts communication by a MIMO (multiple-input multiple-output) transmission scheme.

2. Description of Related Art

In recent years, more and more wireless communication apparatus have come to be equipped with a plurality of systems each comprising an antenna and a transmission/reception circuit. For example, in wireless communication apparatuses adopting a so-called diversity reception scheme, while only one such system is provided on the transmitting part, two or more such systems are provided on the receiving part. Particularly much attention is now being paid to wireless communication apparatuses that adopt a MIMO transmission scheme, which is expected to be put into practical use in next-generation LANs (local area networks) and in fourth-generation cellular phones.

Now, the MIMO transmission scheme will be described briefly below. The MIMO transmission scheme is a widely-known technology for high-speed wireless communication, and has been discussed in a large number of publicly accessible documents. The MIMO transmission scheme itself is dealt with, for example, in the treatise titled “Influence of Propagation Path Route Evaluation in MIMO communication” (published by the Institute of Electronics, Information and Communication Engineers, Japan; included in the Collection of the Lecture Treatises Presented at the 2002 Communication-Branch General Assembly of the Institute of Electronics, Information and Communication Engineers, Japan; treatise number B-5-225; issued on Mar. 7, 2002). According to the MIMO transmission scheme, from a plurality of transmission antennas (p transmission antennas, where p is an integer equal to or greater than 2), as many transmission signals carrying mutually different p pieces of information are transmitted simultaneously at the same frequency (that is, transmitted in parallel); those transmission signals are then received simultaneously via a plurality of reception antennas (q reception antennas, where q is an integer equal to or greater than 2); the thus received q reception signals, which apparently suffer interference among them, are then subjected to necessary calculation operations so that the p pieces of information as they originally were before suffering interference, are restored. By this transmission scheme, it is possible to increase the transmission rate by a factor of p without increasing the occupied frequency band.

FIG. 3 is a circuit configuration diagram showing an example of a conventional wireless communication apparatus adopting the MIMO transmission scheme. The wireless communication apparatus shown in FIG. 3 comprises: four systems of transmission circuits 101, 102, 103, and 104 that transmit signals individually; and a MIMO signal processor 151. Here, reception circuits are omitted from illustration.

The transmission circuits 101, 102, 103, and 104 comprise, respectively: modulators 111, 121, 131, and 141; transmission mixers 112, 122, 132, and 142; transmission amplifiers 113, 123, 133, and 143; antennas 114, 124, 134, and 144; and local signal sources 118, 128, 138, and 148.

Digital data is fed from an unillustrated CPU or the like to the MIMO signal processor 151. In the MIMO signal processor 151, the digital data is subjected to appropriate signal processing for increased resistance to errors, for increased ease of interference elimination on the receiving part, and for other purposes. The digital data is then divided into four digital signals. These four digital signals are mutually different pieces of information as converted into the form of digital signals.

The four digital signals are then, respectively, converted into analog modulation signals by the modulators 111, 121, 131, and 141, then subjected to frequency conversion by the transmission mixers 112, 122, 132, and 142, then amplified by the transmission amplifiers 113, 123, 133, and 143, and then radiated as radio waves from the antennas 114, 124, 134, and 144.

Here, the four local signal sources 118, 128, 138, and 148 oscillate local signals individually but all at the same frequency, and thus, from the four antennas, as many mutually different signals are radiated simultaneously at the same frequency.

The four signals transmitted from the antennas 114, 124, 134, and 144 are received simultaneously via k antennas (where k is an integer equal to or greater than 4) by the receiving part, specifically by a base station (unillustrated) or the like. Then, on the receiving part, specifically in the base station (unillustrated) or the like, the thus received k reception signals, which apparently suffer interference among them, are subjected to necessary calculation operations so that the four pieces of information as they originally were before suffering interference, are restored.

A local signal source is typically built with a PLL (phase-locked loop) circuit or the like, and therefore using a plurality of local signal sources leads to increased cost and to an increased circuit scale. To avoid this, in another conventionally proposed circuit configuration, as shown in FIG. 4, one local signal source 158 is shared among a plurality of transmission mixers 112, 122, 132, and 142. In FIG. 4, such parts as are found also in FIG. 3 are identified with common reference numerals.

On the other hand, Japanese Patent Application Laid-open No. 2004-129066 (hereinafter referred to as Patent Publication 1) discloses a multiple-band wireless transmission/reception apparatus, and describes it as workable in a MIMO-based system (see, among others, paragraph 32 of Patent Publication 1).

The MIMO transmission scheme itself is simply one kind of spatial multiplexing communication scheme, and is therefore typically implemented by being adopted as an option on top of existing communication system standards (for example, in the case of wireless LANs, IEEE (Institute of Electrical and Electronic Engineers) 802.11a and the like). Thus, how to achieve handover is generally prescribed, regardless of the MIMO transmission scheme itself, within the communication system standards that are used as a basis.

The MIMO transmission scheme was put into practical use in wireless LAN apparatuses complying with the IEEE802.11 standards. Here, inconveniently, since the most part of the IEEE802.11 standards inherently give little regard to handover, it has to date been impossible to realize wireless communication apparatuses adopting the MIMO transmission scheme which can achieve smooth handover without an instantaneous interruption.

Patent Publication 1 mentioned above mentions how to achieve handover in a multiple-band transmission/reception apparatus, and also mentions a MIMO-based system. Here, however, Patent Publication 1 simply suggests that the multiple-band transmission/reception apparatus “can achieve handover” and then adds that “it can also work in a MIMO-based system”, if necessary, irrespective of the issue of handover. That is, Patent Publication 1 discloses nothing about how smooth handover can be achieved without an instantaneous interruption in a MIMO-based system.

Although the description above deals with apparatuses that conduct communication on a wireless basis in order to illustrate the conventionally encountered inconveniences, similar inconveniences are experienced also in apparatuses that conduct communication on a wired basis.

### SUMMARY OF THE INVENTION

In view of the conventionally encountered inconveniences discussed above, it is an object of the present invention to provide a communication apparatus (of a wireless or wired type) adopting a MIMO transmission scheme which can achieve smooth handover without an instantaneous interruption.

To achieve the above object, according to the present invention, a communication apparatus adopting a MIMO transmission scheme and including M systems (where M is an integer equal to or greater than 2) of transmission circuits for transmitting signals individually and N systems (where N is an integer equal to or greater than 2) of reception circuits for receiving signals individually is provided with: a control circuit that, when handover from a first communication channel to a second communication channel takes place during communication of information, allocates part of the M systems of transmission circuits and part of the N systems of reception circuits for the establishment of the second communication channel and allocates the rest of the M systems of transmission circuits and of the N systems of reception circuits for the retaining of the first communication channel to continue the communication of information.

Communication of a control signal for handover that is needed to perform handover is conducted by part of the transmission circuits and reception circuits by the use of the second communication channel, which is the handover destination channel. Moreover, even during handover, since the rest of the transmission circuits and reception circuits are allocated for the retaining of the first communication channel, which is the handover departure channel, communication of substantive information can be conducted by the use of the first communication channel. Thus, smooth handover without an instantaneous interruption is achieved. With a configuration in which more than one transmission circuit and more than one reception circuit are allocated for the retaining of the first communication channel during handover, it is possible to maintain high-speed communication by the MIMO transmission scheme even during handover.

Advisably, for example, after the establishment of the second communication channel, the control circuit allocates all of the M systems of transmission circuits and all of the N systems of reception circuits to the second communication channel.

With this configuration, after the completion of handover, communication is restarted by the MIMO transmission scheme by the use of all the transmission circuits and all the reception circuits.

Advisably, for example, there are further provided a first local signal source and a second local signal source each for performing frequency conversion on a to-be-transmitted signal and on a received signal so that, when the handover takes place, the part of the transmission circuits and reception circuits allocated for the establishment of the second communication channel perform transmission and reception by sharing the first local signal source and the rest of the transmission circuits and reception circuits allocated for the retaining of the first communication channel perform transmission and reception by sharing the second local signal source.

With this configuration, it is possible to reduce the number of local signal sources and thereby make the communication apparatus inexpensive and compact.

This configuration, where two local signal sources (a first and a second local signal source) are provided, is particularly suitable for use when the communication apparatus conducts communication by a communication scheme that uses different channel frequencies between before and after handover.

Examples of such communication schemes include FDMA (frequency-division multiple-access) and any other communication scheme that uses different channel frequencies between before and after handover.

Advisably, for example, there is further provided a single local signal source for performing frequency conversion on a to-be-transmitted signal and on a received signal so that all of the M systems of transmission circuits and all of the N systems of reception circuits perform transmission and reception by sharing the single local signal source.

With this configuration, it is possible to reduce the number of local signal sources and thereby make the communication apparatus inexpensive and compact.

This configuration, where a single local signal source is shared, is particularly suitable for use when the communication apparatus conducts communication by a communication scheme that uses the same channel frequency between before and after handover; that is, it is suitable for use with a communication scheme that presumes that the channel frequency of the first communication channel, which is the handover departure channel, and the channel frequency of the second communication channel, which is the handover destination channel, are the same.

Examples of such communication schemes include CDMA (code-division multiple-access), TDMA (time-division multiple-access), and any other communication scheme that uses the same channel frequency between before and after handover.

Advisably, for example, when the handover takes place, two or more systems of transmission circuits and two or more systems of reception circuits are allocated for the establishment of the second communication channel (provided that M≧3 and N≧3), and the communication performed to establish the second communication channel is performed by the MIMO transmission scheme.

With this configuration, a control signal for handover is communicated at high speed by the MIMO transmission scheme, and thus handover can be completed quickly.

Advisably, for example, when the handover takes place, two or more systems of transmission circuits and two or more systems of reception circuits are allocated for the retaining of the first communication channel (provided that M≧3 and N≧3), and the communication of information that is continued through the retaining of the first communication channel is performed by the MIMO transmission scheme.

With this configuration, even during handover, high-speed communication by the MIMO transmission scheme is maintained.

### BRIEF DESCRIPTION OF THE DRAWINGS

FIG. 1 is a circuit configuration diagram of the communication apparatus of a first embodiment of the present invention;

FIG. 2 is a circuit configuration diagram of the communication apparatus of a second embodiment of the present invention;

FIG. 3 is a circuit configuration diagram of a conventional communication apparatus; and

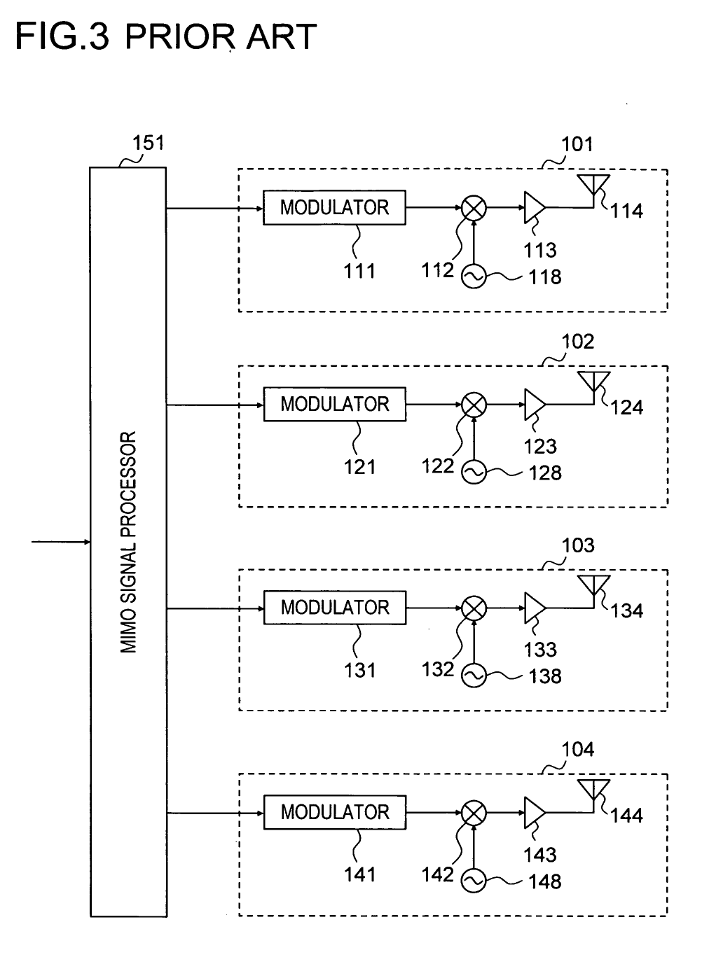

FIG. 4 is a circuit configuration diagram of another conventional communication apparatus.

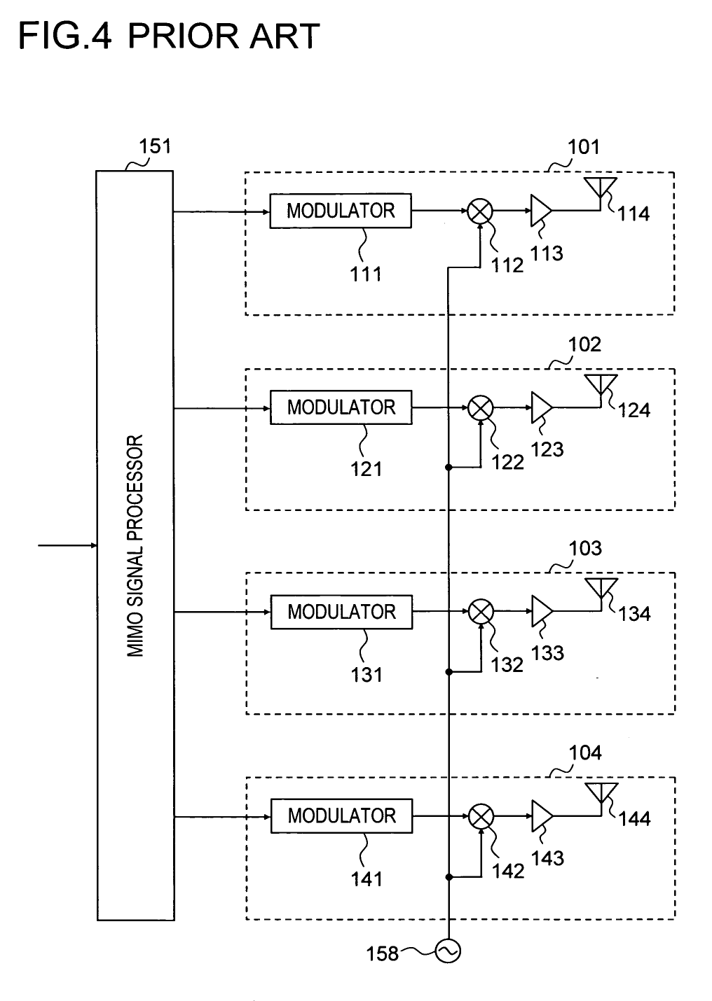

### DETAILED DESCRIPTION OF PREFERRED EMBODIMENTS

### First Embodiment

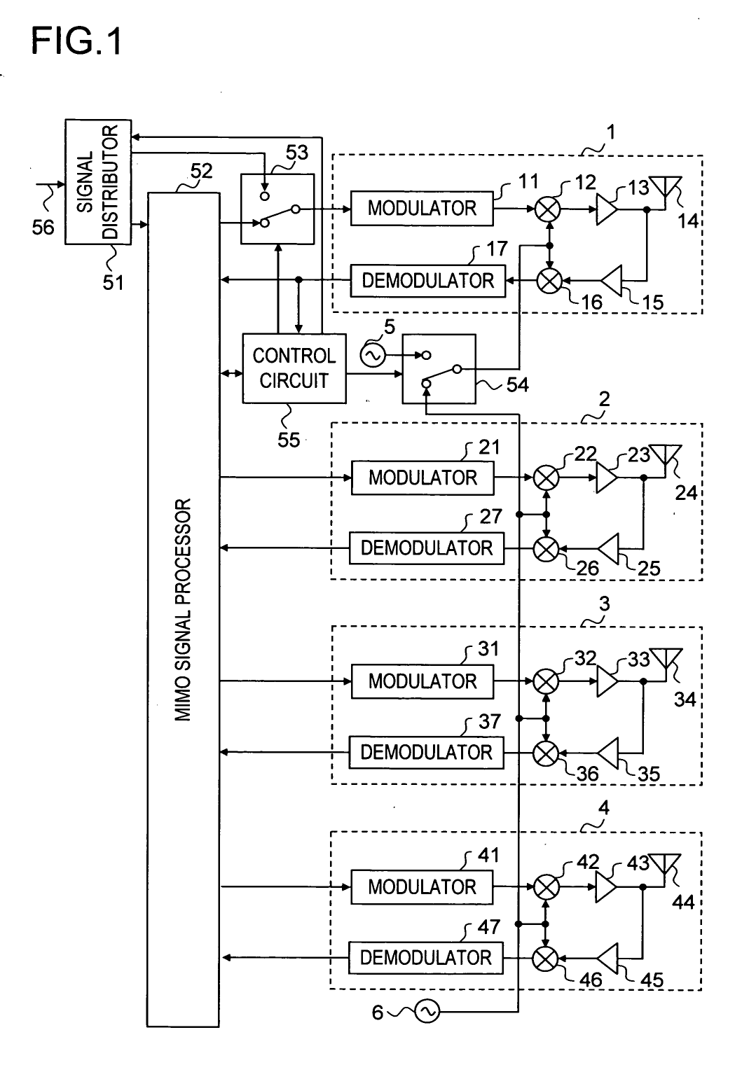

As a first embodiment of the present invention, a communication apparatus will be described below with reference to the drawings. FIG. 1 is a circuit configuration diagram of the communication apparatus of the first embodiment.

The communication apparatus shown in FIG. 1 comprises: four systems of transmission/reception circuits 1, 2, 3, and 4 that transmit and receive signals individually; a first local signal source 5 that oscillates and outputs a first local signal; a second local signal source 6 that oscillates and outputs a second local signal; a signal distributor 51; a MIMO signal processor 52; switches 53 and 54; and a control circuit 55. The communication apparatus conducts wireless communication by a MIMO transmission scheme.

The transmission/reception circuits 1, 2, 3, and 4 comprises, respectively: modulators 11, 21, 31, and 41; transmission mixers 12, 22, 32, and 42 that perform frequency conversion by mixing signals from the modulators 11, 21, 31, and 41 with the first or second local signal; transmission amplifiers 13, 23, 33, and 43; antennas 14, 24, 34, and 44; reception amplifiers 15, 25, 35, and 45; reception mixers 16, 26, 36, and 46 that perform frequency conversion by mixing signals from the reception amplifiers 15, 25, 35, and 45 with the first or second local signal; and demodulators 17, 27, 37, and 47. Except the antennas 14, 24, 34, and 44, all the components constituting the communication apparatus shown in FIG. 1 are housed inside the chassis (unillustrated) of the communication apparatus.

The modulator 11, the transmission mixer 12, the transmission amplifier 13, and the antenna 14 constitute a first transmission circuit for transmitting a signal (for radiating it in the form of a radio wave), and the antenna 14, the reception amplifier 15, the reception mixer 16, and the demodulator 17 constitute a first reception circuit for receiving a signal. Likewise, the modulator 21, the transmission mixer 22, the transmission amplifier 23, and the antenna 24 constitute a second transmission circuit for transmitting a signal, and the antenna 24, the reception amplifier 25, the reception mixer 26, and the demodulator 27 constitute a second reception circuit for receiving a signal. Likewise, the modulator 31, the transmission mixer 32, the transmission amplifier 33, and the antenna 34 constitute a third transmission circuit for transmitting a signal, and the antenna 34, the reception amplifier 35, the reception mixer 36, and the demodulator 37 constitute a third reception circuit for receiving a signal. Likewise, the modulator 41, the transmission mixer 42, the transmission amplifier 43, and the antenna 44 constitute a fourth transmission circuit for transmitting a signal, and the antenna 44, the reception amplifier 45, the reception mixer 46, and the demodulator 47 constitute a fourth reception circuit for receiving a signal.

Under the control of the control circuit 55, the switch 53 connects the input side of the modulator 11 either to the output side of the signal distributor 51 or to the output side of the MIMO signal processor 52. Under the control of the control circuit 55, the switch 54 connects either the output side of the first local signal source 5 or the output side of the second local signal source 6 to the transmission mixer 12 and the reception mixer 16.

The first local signal source 5 generates a first local signal. When the output side of the first local signal source 5 is connected to the transmission mixer 12 and the reception mixer 16, the first local signal is fed via the switch 54 to the transmission mixer 12 and the reception mixer 16.

The second local signal source 6 generates a second local signal. The second local signal is fed to the transmission mixers 22, 32, and 42 and to the reception mixers 26, 36, and 46, and, when the output side of the second local signal source 6 is connected to the transmission mixer 12 and the reception mixer 16, the second local signal is also fed via the switch 54 to the transmission mixer 12 and the reception mixer 16.

Ordinary Communication Operation

In the wireless communication apparatus configured as described above, when no consideration is given to handover, communication operation (in the following description, such communication operation will be referred to also as “ordinary communication operation”) proceeds as described below. In ordinary communication operation, the control circuit 55 controls the switch 53 so that the output side of the MIMO signal processor 52 is connected to the input side of the modulator 11, and controls the switch 54 so that the output side of the second local signal source 6 is connected to the transmission mixer 12 and the reception mixer 16 (now the states of the switches 53 and 54 are just as shown in FIG. 1). In addition, the control circuit 55 controls the signal distributor 51 and the MIMO signal processor 52 so that the sequence of operations described below is performed. The second local signal source 6 oscillates at an appropriate frequency that suits the currently selected communication channel to output the second local signal at that appropriate frequency.

First, a description will be given of a case where, in ordinary communication operation, the communication apparatus shown in FIG. 1 operates as the transmitting part. In this case, a signal is transmitted through the following sequence of operations. Digital data is fed from an unillustrated CPU or the like via a conductor 56 to the communication apparatus. The digital data passes through the signal distributor 51 unaffected, and is fed to the MIMO signal processor 52. In the MIMO signal processor 52, the digital data is subjected to appropriate signal processing for increased resistance to errors, for increased ease of interference elimination on the receiving part, and for other purposes, and is then divided into four digital signals, namely a first digital signal, a second digital signal, a third digital signal, and a fourth digital signal. These four digital signals are mutually different pieces of information as converted into the form of digital signals.

The first, second, third, and fourth digital signals are, respectively, converted into analog modulation signals by the modulators 11, 21, 31, and 41, then subjected to frequency conversion by the transmission mixers 12, 22, 32, and 42, then amplified by the transmission amplifiers 13, 23, 33, and 43, and then radiated as radio waves from the antennas 14, 24, 34, and 44.

Here, the transmission mixers 12, 22, 32, and 42 are all fed with the same second local signal, and thus they perform frequency conversion by respectively mixing the analog modulation signals from the modulators 11, 21, 31, and 41 with the second local signal. Thus, the mutually different four pieces of information are transmitted simultaneously at the same frequency.

The four signals transmitted from the antennas 14, 24, 34, and 44 are received simultaneously via k antennas (where k is an integer equal to or greater than 4) by the receiving part, specifically by a base station (unillustrated) or the like. Then, on the receiving part, specifically in the base station (unillustrated) or the like, the thus received k reception signals, which apparently suffer interference among them, are subjected to necessary calculation operations so that the four pieces of information as they originally were before suffering interference, are restored.

Next, a description will be given of a case where, in ordinary communication operation, the communication apparatus shown in FIG. 1 operates as the receiving part. In this case, the transmitting part, specifically a base station (unillustrated) or the like, transmits, simultaneously at the same frequency, mutually different four pieces of information (it should be noted that these are different from the above-mentioned four pieces of information which the communication apparatus shown in FIG. 1 transmits when operating as the transmitting part, and may consist of three or less pieces of information). The thus transmitted signals are transmitted at an appropriate frequency that suits the currently selected communication channel. The antennas 14, 24, 34, and 44 each receive simultaneously the signals carrying the four pieces of information transmitted from the base station (unillustrated) or the like.

The signals received via the antennas 14, 24, 34, and 44 are, respectively, amplified by the reception amplifiers 15, 25, 35, and 45, then subjected to frequency conversion by the reception mixers 16, 26, 36, and 46, then demodulated into digital signals by the demodulators 17, 27, 37, and 47, and then fed to the MIMO signal processor 52. In the MIMO signal processor 52, the four reception signals, which apparently suffer interference among them, are subjected to necessary calculation operations so that the four pieces of information as they originally were before suffering interference, are restored.

In this way, in ordinary communication operation, communication (transmission and reception) is conducted by the MIMO transmission scheme. This makes it possible to increase the transmission rate by a factor of four without increasing the occupied frequency band.

In the configuration specifically described above, the second local signal source 6 is shared among the transmission mixers 22, 32, and 42 and the reception mixers 26, 36, and 46. It is alternatively possible to provide separate local signal sources one for each of those mixers. From the viewpoint of making the communication apparatus inexpensive and compact, however, it is preferable that a single second local signal source 6 be shared as shown in FIG. 1. In the configuration specifically described above, in ordinary communication operation, the transmission mixer 12 and the reception mixer 16 also share the second local signal source 6. It is alternatively possible to connect the output side of the first local signal source 5 to the transmission mixer 12 and the reception mixer 16 so that the separate first local signal source 5 is used instead. In ordinary communication operation, however, since the transmission mixer 12 and the reception mixer 16 use a local signal having the same frequency as those used by the other mixers like the transmission mixer 22, it is preferable that, as described above, the second local signal source 6 be shared via the switch 54.

Handover Operation

By contrast, when handover is taking place, that is, when switching from a first communication channel to a second communication channel is taking place, operation proceeds as described below. In the following description, the period from the start to the end of a session of handover will be referred to as the handover period. During the handover period, the control circuit 55 controls the switch 53 so that the output side of the signal distributor 51 is connected to the input side of the modulator 11 without passing through the MIMO signal processor 52.

The control circuit 55 controls the switch 54 so that the output side of the first local signal source 5 is connected to the transmission mixer 12 and the reception mixer 16. Now, the transmission mixer 12 and the reception mixer 16 are separated from the other mixers like the transmission mixer 22 by the switch 54, and are thus fed with the first local signal from the first local signal source 5. During the handover period, under the control of the control circuit 55, the first local signal source 5 oscillates at an appropriate frequency that suits the second communication channel to output the first local signal at that appropriate frequency. During the handover period, under the control of the control circuit 55, the second local signal source 6 oscillates at an appropriate frequency that suits the first communication channel, that is, the currently selected channel, to output the second local signal at that appropriate frequency. In addition, the control circuit 55 controls the signal distributor 51 and the MIMO signal processor 52 so that the sequence of operations described below is performed.

Digital data is fed from the unillustrated CPU or the like via the conductor 56 to the communication apparatus. The digital data is then split between two paths by the signal distributor 51. Along one path, the digital data, along with a control signal for handover, is fed via the switch 53 directly to the modulator 11, then converted into an analog modulation signal by the modulator 11, then subjected to frequency conversion by the transmission mixer 12, then amplified by the transmission amplifier 13, and then transmitted as a radio wave from the antenna 14.

The control signal for handover that is transmitted from the antenna 14 is received by a base station (unillustrated) or the like, which then transmits, at a frequency corresponding to the second communication channel, a signal that needs to be transmitted to the communication apparatus shown in FIG. 1 to make it switch the communication channel from the first communication channel to the second communication channel (as such, this signal also is a control signal for handover). This signal is thus received by the communication apparatus via the antenna 14. The received signal is then amplified by the reception amplifier 15, then subjected to frequency conversion by the reception mixer 16, then demodulated by the demodulator 17, and then fed to the control circuit 55, which then, by using the signal, establishes the second communication channel.

In this way, when handover takes place, the transmission/reception circuit 1 is allocated for the establishment of the second communication channel, that is, the channel to be newly used as the handover destination channel. More specifically, the communication of control signals for handover between the transmission/reception circuit 1 and the base station (unillustrated) is conducted by an ordinary one-to-one communication scheme different from the MIMO transmission scheme by using the second communication channel, and, through this communication, the second communication channel is established.

Along the other path after the splitting by the signal distributor 51, the digital data is fed to the MIMO signal processor 52, where the digital signal is subjected to appropriate signal processing for increased resistance to errors, for increased ease of interference elimination, and for other purposes, and is then divided into three digital signals. These three digital signals are mutually different pieces of information as converted into the form of digital signals.

These three digital signals are then, respectively, converted into analog modulation signals by the modulators 21, 31, and 41, then subjected to frequency conversion by the transmission mixers 22, 32, and 42, then amplified by the transmission amplifiers 23, 33, and 43, and then transmitted as radio waves from the antennas 24, 34, and 44. The three pieces of information corresponding to these three digital signals are, as in ordinary communication operation, transmitted simultaneously at the same frequency so that, on the receiving part, specifically in the base station (unillustrated) or the like, the three pieces of information are restored.

During the handover period, in a case where a base station (unillustrated) or the like operates as the transmitting part, the transmitting part, specifically the base station (unillustrated) or the like, transmits, simultaneously at the same frequency corresponding to the first communication channel, mutually different three pieces of information (it should be noted that these are different from the above-mentioned three pieces of information which the communication apparatus shown in FIG. 1 transmits when operating as the transmitting part, and may consist of two or less pieces of information). The antennas 24, 34, and 44 each receive simultaneously the three pieces of information transmitted from the base station (unillustrated) or the like.

The signals received via the antennas 24, 34, and 44 are, respectively, amplified by the reception amplifiers 25, 35, and 45, then subjected to frequency conversion by the reception mixers 26, 36, and 46, then demodulated by the demodulators 27, 37, and 47, and then fed to the MIMO signal processor 52. In the MIMO signal processor 52, the three reception signals, which apparently suffer interference among them, are subjected to necessary calculation operations so that the three pieces of information as they originally were before suffering interference, are restored.

In this way, even during the handover period, the first communication channel is retained so that communication by the MIMO transmission scheme can be continued via the first communication channel. Thus, here, the number of transmission/reception circuits allocated for communication by the MIMO transmission scheme is reduced from four (in ordinary communication operation) to three, and thus the communication speed is accordingly reduced to about ¾, but, still, high-speed communication (transmission and reception) by the MIMO transmission scheme can be maintained even during the handover period.

On recognizing that the second communication channel has been established, the control circuit 55 controls the second local signal source 6 to make it oscillate and output a second local signal at an appropriate frequency that suits the second communication channel. Moreover, in order that the above-described sequence of operations for ordinary communication operation is performed, the control circuit 55 controls the switch 53 so that the output side of the MIMO signal processor 52 is connected to the input side of the modulator 11, and controls the switch 54 so that the output side of the second local signal source 6 is connected to the transmission mixer 12 and the reception mixer 16. Furthermore, the control circuit 55 controls the signal distributor 51 and the MIMO signal processor 52 so that communication is performed by the MIMO transmission scheme by the use of four systems of transmission/reception circuits.

In this way, the four systems of transmission/reception circuits 1, 2, 3, and 4 have now all shifted to the second communication channel (that is, they are now allocated to the second communication channel), so that communication by the MIMO transmission scheme by the use of four systems of transmission/reception circuits, as inherently intended, is restarted.

As described above, during the handover period, part of the four systems of transmission/reception circuits (in this embodiment, one system, specifically the transmission/reception circuit 1) are allocated for the establishment of the second communication channel (allocated to the second communication channel), which is the handover destination channel, and the rest of the systems (in this embodiment, three systems, namely the transmission/reception circuits 2, 3, and 4) are allocated for the retaining of the first communication channel (allocated to the first communication channel), which is the handover departure channel, so that communication of substantive information is continued. Thus, smooth handover without an instantaneous interruption can be achieved. Moreover, even when handover is taking place, high-speed communication by the MIMO transmission scheme is maintained.

Moreover, during the handover period, the first local signal source 5 is shared between the first transmission circuit and the first reception circuit (these are included in the transmission/reception circuit 1), which are allocated for the establishment of the second communication channel, and the second local signal source 6 is shared among the second transmission circuit and the second reception circuit (these are included in the transmission/reception circuit 2), the third transmission circuit and the third reception circuit (these are included in the transmission/reception circuit 3), and the fourth transmission circuit and the fourth reception circuit (these are included in the transmission/reception circuit 4), which are all allocated for the retaining of the first communication channel.

Since a local signal source that oscillates and outputs a local signal is built with a PLL (phase-locked loop) circuit or the like, using a large number of local signal sources leads to increased cost and to an increased circuit scale. By sharing a limited number of local signal sources as described above, it is possible to make the communication apparatus inexpensive and compact.

In the configuration specifically described above, during the handover period, digital data is fed from the unillustrated CPU or the like via the conductor 56 to the communication apparatus, and the digital data is then split between two paths by the signal distributor 51 so that, along one path, the digital data, along with a control signal for handover, is fed via the switch 53 directly to the modulator 11. It is, however, not absolutely necessary to split the digital data between two paths with the signal distributor 51, and it is alternatively possible to distribute the digital data to the modulator 11 as necessary. Accordingly, during the handover period, the digital data fed from the unillustrated CPU or the like via the conductor 56 to the communication apparatus may be fed intact to the MIMO signal processor 52, with a control signal for handover alone fed to the modulator 11.

### Second Embodiment

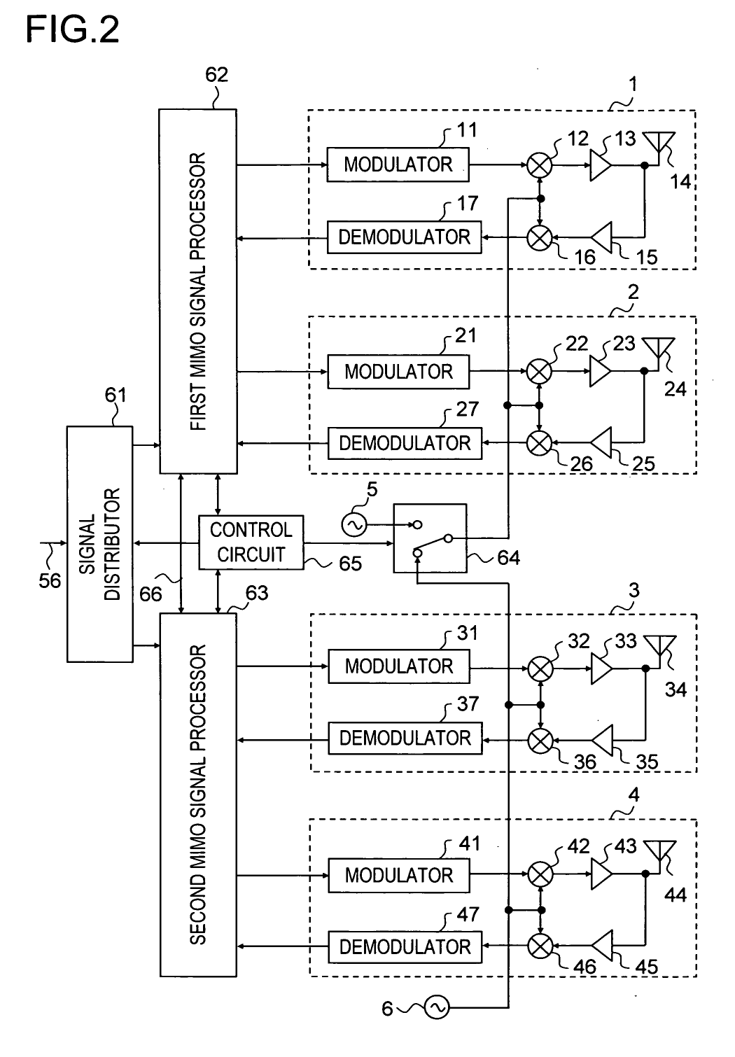

Next, as a second embodiment of the present invention, another communication apparatus will be described below with reference to the drawings. This embodiment deals with a case where two systems of transmission/reception circuits are allocated for the establishment of a new communication channel when handover takes place. FIG. 2 is a circuit configuration diagram of the communication apparatus of the second embodiment. In FIG. 2, such parts as are found also in FIG. 1 are identified with common reference numerals, and no explanation will be repeated of the operation and other features of those parts.

The communication apparatus shown in FIG. 2 comprises: transmission/reception circuits 1, 2, 3, and 4; a first local signal source 5 that oscillates and outputs a first local signal; a second local signal source 6 that oscillates and outputs a second local signal; a signal distributor 61; a first MIMO signal processor 62; a second MIMO signal processor 63; a switch 64; and a control circuit 65. This communication apparatus, like that of the first embodiment, conducts wireless communication by a MIMO transmission scheme. Except the antennas 14, 24, 34, and 44, all the components constituting the communication apparatus shown in FIG. 2 are housed inside the chassis (unillustrated) of the communication apparatus.

Under the control of the control circuit 65, the switch 64 connects either the output side of the first local signal source 5 or the output side of the second local signal source 6 to the transmission mixers 12 and 22 and to the reception mixers 16 and 26 (hereinafter referred to as the “mixers 12, 22, 16, and 26”).

The first local signal source 5 generates a first local signal. When the output side of the first local signal source 5 is connected to the mixers 12, 22, 16, and 26, the first local signal is fed via the switch 64 to the mixers 12, 22, 16, and 26.

The second local signal source 6 generates a second local signal. The second local signal is fed to the transmission mixers 32 and 42 and to the reception mixers 36 and 46, and, when the output side of the second local signal source 6 is connected to the mixers 12, 22, 16, and 26, the second local signal is also fed via the switch 64 to the mixers 12, 22, 16, and 26.

Ordinary Communication Operation

In the wireless communication apparatus configured as described above, when no consideration is given to handover, ordinary communication operation proceeds as described below. In ordinary communication operation, the control circuit 65 controls the switch 64 so that the output side of the second local signal source 6 is connected to the mixers 12, 22, 16, and 26 (now the state of the switch 64 is just as show in FIG. 2). In addition, the control circuit 65 controls the signal distributor 61 and the first and second MIMO signal processors 62 and 63 so that the sequence of operations described below is performed. The second local signal source 6 oscillates at an appropriate frequency that suits the currently selected communication channel to output the second local signal at that appropriate frequency.

First, a description will be given of a case where, in ordinary communication operation, the communication apparatus shown in FIG. 2 operates as the transmitting part. In this case, a signal is transmitted through the following sequence of operations. Digital data is fed from an unillustrated CPU or the like via a conductor 56 to the communication apparatus. The digital data is divided into two different parts of digital data by the signal distributor 61, of which one is fed to the first MIMO signal processor 62 and the other to the second MIMO signal processor 63.

The two MIMO signal processors 62 and 63 exchange necessary information with each other via a conductor 66 to operate in a coordinated fashion in order to perform, on the digital data they respectively receive, appropriate signal processing for increased resistance to errors, for increased ease of interference elimination, and for other purposes. Then, the two MIMO signal processors 62 and 63 output the digital data in the form of four different digital signals. These four digital signals are mutually different pieces of information as converted into digital signals, of which two are outputted from the first MIMO signal processor 62 and are fed to the modulators 11 and 21 and the other two are outputted from the second MIMO signal processor 63 and are fed to the modulators 31 and 41.

The four digital signals are, respectively, converted into analog modulation signals by the modulator 11, 21, 31, and 41, then subjected to frequency conversion by the transmission mixers 12, 22, 32, and 42, then amplified by the transmission amplifiers 13, 23, 33, and 43, and then radiated as radio waves from the antennas 14, 24, 34, and 44.

Here, the transmission mixers 12, 22, 32, and 42 are all fed with the same second local signal, and thus they perform frequency conversion by respectively mixing the analog modulation signals from the modulators 11, 21, 31, and 41 with the second local signal. Thus, the mutually different four pieces of information are transmitted simultaneously at the same frequency.

The four signals transmitted from the antennas 14, 24, 34, and 44 are received simultaneously via each of k antennas (where k is an integer equal to or greater than 4) by the receiving part, specifically by a base station (unillustrated) or the like. Then, on the receiving part, specifically in the base station (unillustrated) or the like, the thus received k reception signals, which apparently suffer interference among them, are subjected to necessary calculation operations so that the four pieces of information as they originally were before suffering interference, are restored.

Next, a description will be given of a case where, in ordinary communication operation, the communication apparatus shown in FIG. 2 operates as the receiving part. In this case, the transmitting part, specifically a base station (unillustrated) or the like, transmits, simultaneously at the same frequency, mutually different four pieces of information (it should be noted that these are different from the above-mentioned four pieces of information which the communication apparatus shown in FIG. 2 transmits when operating as the transmitting part, and may consist of three or less pieces of information). The thus transmitted signals are transmitted at an appropriate frequency that suits the currently selected communication channel. The antennas 14, 24, 34, and 44 each receive simultaneously the signals carrying the four pieces of information transmitted from the base station (unillustrated) or the like.

The signals received via the antennas 14 and 24 are, respectively, amplified by the reception amplifiers 15 and 25, then subjected to frequency conversion by the reception mixers 16 and 26, then demodulated into digital signals by the demodulators 17 and 27, and then fed to the first MIMO signal processor 62. The signals received via the antennas 34 and 44 are, respectively, amplified by the reception amplifiers 35 and 45, then subjected to frequency conversion by the reception mixers 36 and 46, then demodulated into digital signals by the demodulators 37 and 47, and then fed to the second MIMO signal processor 63. The two MIMO signal processors 62 and 63 exchange necessary information with each other via the conductor 66 to operate in a coordinated fashion, and thereby performs necessary calculation operations on the four received signals, which apparently suffer interference among them, to restore the four pieces of information as they originally were before suffering interference.

In this way, in ordinary communication operation, communication (transmission and reception) is conducted by the MIMO transmission scheme. This makes it possible to increase the transmission rate by a factor of four without increasing the occupied frequency band.

In the configuration specifically described above, the second local signal source 6 is shared among the transmission mixers 32 and 42 and the reception mixers 36 and 46. It is alternatively possible to provide separate local signal sources one for each of those mixers. From the viewpoint of making the communication apparatus inexpensive and compact, however, it is preferable that a single second local signal source 6 be shared as shown in FIG. 2. In the configuration specifically described above, in ordinary communication operation, the mixers 12, 22, 16, and 26 also share the second local signal source 6. It is alternatively possible to connect the output side of the first local signal source 5 to the mixers 12, 22, 16, and 26 so that the separate first local signal source 5 is used instead. In ordinary communication operation, however, since the mixers 12, 22, 16, and 26 use a local signal having the same frequency as those used by the other mixers like the transmission mixer 32, it is preferable that, as described above, the second local signal source 6 be shared via the switch 64.

Handover Operation

By contrast, when handover is taking place, that is, when switching from a first communication channel to a second communication channel is taking place, operation proceeds as described below. During the handover period, the control circuit 65 controls the switch 64 so that the output side of the first local signal source 5 is connected to the mixers 12, 22, 16, and 26. Now, the mixers 12, 22, 16, and 26 are separated from the other mixers like the transmission mixer 32 by the switch 64, and are thus fed with the first local signal from the first local signal source 5.

During the handover period, under the control of the control circuit 65, the first local signal source 5 oscillates at an appropriate frequency that suits the second communication channel to output the first local signal at that appropriate frequency. During the handover period, under the control of the control circuit 65, the second local signal source 6 oscillates at an appropriate frequency that suits the first communication channel, that is, the currently selected channel, to output the second local signal at that appropriate frequency. In addition, the control circuit 65 controls the signal distributor 61 and the first and second MIMO signal processors 62 and 63 so that the sequence of operations described below is performed.

Digital data is fed from the unillustrated CPU or the like via the conductor 56 to the communication apparatus. The digital data is then split between two paths by the signal distributor 61. Along one path, the digital data, along with a control signal for handover, is fed to the first MIMO signal processor 62, and, along the other path, the digital data is fed to the second MIMO signal processor 63.

Independently of the second MIMO signal processor 63, the first MIMO signal processor 62 performs, on the digital data fed thereto, appropriate signal processing for increased resistance to errors, for increased ease of interference elimination, and for other purposes, and divides the digital data to output it in the form of two different digital signals. Independently of the first MIMO signal processor 62, the second MIMO signal processor 63 performs, on the digital data fed thereto, appropriate signal processing for increased resistance to errors, for increased ease of interference elimination, and for other purposes, and divides the digital data to output it in the form of two different digital signals. The two digital signals outputted from the first MIMO signal processor 62 are fed respectively to the modulators 11 and 21, and the two digital signals outputted from the second MIMO signal processor 63 are fed respectively to the modulators 31 and 41. Thus, the two MIMO signal processors 62 and 63 together output a total of four digital signals, which are mutually different pieces of information as converted into digital signals.

The four digital signals are then, respectively, converted into analog modulation signals by the modulators 11, 21, 31, and 41, then subjected to frequency conversion by the transmission mixers 12, 22, 32, and 42, then amplified by the transmission amplifiers 13, 23, 33, and 43, and then radiated as radio waves from the antennas 14, 24, 34, and 44.

On receiving a control signal for handover that is transmitted from the antennas 14 and 24, the base station (unillustrated) or the like transmits, simultaneously at the same frequency corresponding to the second communication channel, mutually different two signals that need to be transmitted to the communication apparatus shown in FIG. 2 to make it switch the communication channel from the first communication channel to the second communication channel (as such, these signals also are control signals for handover) to the communication apparatus shown in FIG. 2. These signals are thus received simultaneously by the communication apparatus via the antennas 14 and 24. The signals received via the antennas 14 and 24 are then, respectively, amplified by the reception amplifiers 15 and 25, then subjected to frequency conversion by the reception mixers 16 and 26, then demodulated by the demodulators 17 and 27, and then fed to the first MIMO signal processor 62. The first MIMO signal processor 62 performs necessary calculation operations on the two received signals, which apparently suffer interference between them, and thereby restores the two pieces of information as they originally were before suffering interference. The thus restored two pieces of information are fed to the control circuit 65, which then, by using them, establishes the second communication channel.

In this way, when handover takes place, the transmission/reception circuits 1 and 2 are allocated for the establishment of the second communication channel, that is, the channel to be newly used as the handover destination channel. More specifically, the communication of control signals for handover between the transmission/reception circuits 1 and 2 and the base station (unillustrated) is conducted through high-speed communication by the MIMO transmission scheme by using the second communication channel. This permits quick establishment of the second communication channel.

On the other hand, the two pieces of information transmitted from the antennas 34 and 35 are transmitted simultaneously at the same frequency corresponding to the first communication channel, just as in ordinary communication operation. The base station (unillustrated) or the like then restores the two pieces of information.

During the handover period, in a case where a base station (unillustrated) or the like operates as the transmitting part, the transmitting part, specifically the base station (unillustrated) or the like, transmits, simultaneously at the same frequency corresponding to the first communication channel, mutually different two pieces of information. The antennas 34 and 44 each receive simultaneously the two pieces of information transmitted from the base station (unillustrated) or the like.

The signals received via the antennas 34 and 44 are, respectively, amplified by the reception amplifiers 35 and 45, then subjected to frequency conversion by the reception mixers 36 and 46, then demodulated by the demodulators 37 and 47, and then fed to the second MIMO signal processor 63. In the second MIMO signal processor 63, the two reception signals, which apparently suffer interference between them, are subjected to necessary calculation operations so that the two pieces of information as they originally were before suffering interference, are restored.

In this way, even during the handover period, the first communication channel is retained so that communication by the MIMO transmission scheme can be continued via the first communication channel. Thus, here, the number of transmission/reception circuits allocated for communication by the MIMO transmission scheme is reduced from four (in ordinary communication operation) to two, and thus the communication speed is accordingly reduced to about 2/4, but, still, high-speed communication (transmission and reception) by the MIMO transmission scheme can be maintained even during the handover period.

On recognizing that the second communication channel has been established, the control circuit 65 controls the second local signal source 6 to make it oscillate and output a second local signal at an appropriate frequency that suits the second communication channel. Moreover, in order that the above-described sequence of operations for ordinary communication operation is performed, the control circuit 65 controls the switch 64 so that the output side of second local signal source 6 is connected to the mixers 12, 22, 16, and 26. Furthermore, the control circuit 65 controls the signal distributor 61 and the first and second MIMO signal processor 62 and 63 so that communication is performed by the MIMO transmission scheme by the use of four systems of transmission/reception circuits.

In this way, the four systems of transmission/reception circuits 1, 2, 3, and 4 have now all shifted to the new second communication channel (that is, they are now allocated to the second communication channel), so that communication by the MIMO transmission scheme by the use of four transmission/reception circuits, as inherently intended, is restarted.

As described above, during the handover period, part of the four systems of transmission/reception circuits (in this embodiment, two systems, specifically the transmission/reception circuits 1 and 2) are allocated for the establishment of the second communication channel (allocated to the second communication channel), which is the handover destination channel, and the rest of the systems (in this embodiment, two systems, namely the transmission/reception circuits 3 and 4) are allocated for the retaining of the first communication channel (allocated to the first communication channel), which is the handover departure channel, so that communication of substantive information is continued. Thus, smooth handover without an instantaneous interruption can be achieved. Moreover, even when handover is taking place, high-speed communication by the MIMO transmission scheme is maintained.

Moreover, during the handover period, the first local signal source 5 is shared among the first transmission circuit and the first reception circuit (these are included in the transmission/reception circuit 1) and the second transmission circuit and the second reception circuit (these are included in the transmission/reception circuit 2), which are all allocated for the establishment of the second communication channel, and the second local signal source 6 is shared among the third transmission circuit and the third reception circuit (these are included in the transmission/reception circuit 3) and the fourth transmission circuit and the fourth reception circuit (these are included in the transmission/reception circuit 4), which are all allocated for the retaining of the first communication channel. By sharing a limited number of local signal sources in this way, it is possible, as in the first embodiment, to make the communication apparatus inexpensive and compact.

In the configuration specifically described above, during the handover period, digital data is fed from the unillustrated CPU or the like via the conductor 56 to the communication apparatus, and the digital data is then split between two paths by the signal distributor 61 so that, along one path, the digital data, along with a control signal for handover, is fed to the first MIMO signal processor 62. It is, however, not absolutely necessary to split the digital data between two paths with the signal distributor 61, and it is alternatively possible to distribute the digital data to the first MIMO signal processor 62 as necessary. Accordingly, during the handover period, the digital data fed from the unillustrated CPU or the like via the conductor 56 to the communication apparatus may be fed intact to the second MIMO signal processor 63, with a control signal for handover alone fed to the first MIMO signal processor 62.

### Modifications to the First and Second Embodiments

Examples of modifications applicable to the first and second embodiments described above will be described below. Generally, in a communication system adopting a communication scheme other than the CDMA and TDMA schemes (for example, a communication system adopting the FDMA scheme), performing handover involves switching the oscillation frequency of a local signal source so that the channel frequency (the frequency assigned to the communication channel currently used) is shifted to a new frequency, that is, a frequency that is different from the one that has thus far been used. In a case where communication is conducted by a communication scheme that uses different channel frequencies between before and after handover (for example, in a communication system adopting the FDMA scheme), the configurations described above as the first and second embodiments are suitable. In a communication system adopting the CDMA or TDMA communication scheme, on the other hand, there is a possibility that the channel frequency of the old communication channel, that is, the one before handover, and the channel frequency of the new communication channel, that is, the one after handover, are equal.

In a case where the communication apparatus of the first or second embodiment (FIGS. 1 and 2, respectively) is used in a communication system that, as just mentioned, permits handover between equal frequencies, that is, a communication system that uses the same channel frequency between before and after handover, there is no need to separately provide the first and second local signal sources 5 and 6 and make them oscillate independently; that is, there may be provided a single local signal source instead. Specifically, for example, the first local signal source 5 is omitted from the communication apparatus, and, not only in ordinary communication operation but also during the handover period, the second local signal oscillated by and outputted from the second local signal source 6 is fed to all of the transmission mixers 12, 22, 32, and 42 and the reception mixers 16, 26, 36, and 46. This makes it possible to make the communication apparatus more inexpensive and compact

Here, the FDMA, CDMA, and TDMA schemes are mentioned as examples of communication schemes that are often adopted in communication systems. It should however be understood that there exist also communication systems that conduct communication by using more than one of those schemes in a combined fashion, and therefore that it is often difficult to tell exactly which of the FDMA, CDMA, and TDMA schemes a particular communication system adopts.

Accordingly, the communication scheme that is suitably adopted with the configuration described above as the first or second embodiment is not limited to the TDMA scheme, nor is the communication scheme that is suitably adopted with the configuration modified so that “a single local signal source is used instead of two” as described above limited to the CDMA or TDMA scheme. To sum up, the configuration described above as the first or second embodiment is suitable for use with a communication scheme that uses different channel frequencies between before and after handover, and the configuration modified so that “a single local signal source is used instead of two” as described above is particularly suitable with a communication scheme that uses the same channel frequency between before and after handover. Needless to say, the configurations described above as the first and second embodiments may be used with a communication scheme that uses the same channel frequency between before and after handover.

Handover

The term “handover” is used to denote the shifting of the communication channel from one base station to another that takes place as a communication apparatus such as a cellular phone moves around. In the context of the present invention, the term is used, in addition to the shifting of a new base station (communication partner) as just mentioned, also to the shifting to a new frequency (frequency band) within the same base station. This will be described below.

The MIMO transmission scheme is expected to be widely used in wireless LANs complying with IEEE (Institute of Electrical and Electronic Engineers) 802.11n. In this case, the type of handover that can frequently take place is one that takes place during communication from one frequency to another (for example, from the 2.4 GHz band to the 5 GHz band) with respect to a single base station (access point).

Wireless LANs complying with IEEE802.1 In are supposed to be downward compatible with their predecessors, namely wireless LANs complying with IEEE802.11a (5 GHz band) and those complying with IEEE802.11b/g (2.4 GHz band), and are thus expected to be implemented as dual-band products that continue communication while freely shifting between the two frequency bands (5 GHz and 2.4 GHz bands).

For example, when the first embodiment (FIG. 1) is applied to such a dual-band product, operation proceeds as follows. Suppose, for example, the following happens. While a video signal is being wirelessly transmitted through high-speed communication by the MIMO transmission scheme in the 2.4 GHz band, a microwave oven or another wireless LAN nearby starts to operate and thereby starts degrading the radio wave environment. In this case, the access point automatically instructs the dual-band product incorporating the communication apparatus shown in FIG. 1 to automatically shift the channel frequency from the 2.4 GHz band to the 5 GHz band, where no interference from the microwave oven or the like is likely.

In this way, with respect to a single access point, handover is achieved automatically from one channel frequency to another. As described above, according to the present invention, smooth handover can be achieved without an instantaneous interruption, and in addition high-speed communication by the MIMO transmission scheme is maintained even during handover. This keeps the user completely or almost unaware of the shifting of the frequency band.

Establishment of a Communication Channel

What the establishment of a communication channel (in the embodiments described above, the establishment of the second communication channel) means is as follows. Between two communication apparatuses, a sequence of operations is performed to confirm that a particular communication channel is vacant, then transmit a communication start request to the partner via that communication channel, then, after receiving a reply permitting communication from the partner, start to conduct communication stably via that communication channel (or, after receiving a reply permitting communication from the partner, enable it to start to conduct communication stably via that communication channel).

It should however be understood that the meaning of “the establishment of a communication channel” given above is merely one representative example thereof, and the sequence of operations actually performed for the establishment of a communication channel differs in detail from one communication system to another. Thus, needless to say, the meaning of “the establishment of a communication channel” as used in the context of the present invention is not limited to the just given meaning.

### Modifications etc.

The first and second embodiments deal with communication apparatuses comprising four systems of transmission/reception circuits. Needless to say, the number of systems of transmission/reception circuits is not limited to four, but may be any number equal to or greater than two. It should however be noted that, when the number is two, communication by the MIMO transmission scheme is interrupted during handover. The second embodiments deals with an example where the number of systems of transmission/reception circuits allocated for the establishment of the second communication channel and the number of systems of transmission/reception circuits allocated for the retaining of the first communication channel are each two. These numbers may respectively be, when the total number of systems of transmission/reception circuits is five, “2 and 3”, or “3 and 2” or even “4 and 1”.

In each of the transmission/reception circuits shown in FIGS. 1 and 2, the antenna (like the antenna 14) may be built with two separate antennas, namely one transmission antenna and one reception antenna. In this case, the signal outputted from the transmission amplifier 13 of the transmission/reception circuit 1 is transmitted as a radio wave from the transmission antenna, and a signal received via the reception antenna is fed to the reception amplifier 15. The same applies to the transmission/reception circuits 2, 3, and 4.

In the first and second embodiments (the communication apparatuses shown in FIGS. 1 and 2), there are provided equal numbers of transmission circuits (for example, the first transmission circuit) and reception circuits (for example, the first reception circuit). These numbers does not necessarily have to be equal. In a case where there are provided different numbers of them, antennas (like the antenna 14) may each be built with a transmission antenna and a reception antenna as described above. Generally, any numbers of transmission circuits (transmission antennas) and reception circuits (reception antennas) may be provided so long as the following relationship holds: 2≦the number of transmission circuits (transmission antenna)≦the number of reception circuits (reception antennas).

This relationship applies also between the communication apparatus shown in FIG. 1 or 2 and its communication partner, namely a base station or the like. Accordingly, the communication apparatus needs to be configured to fulfill the following relationships: 2≦the number of transmission circuits (transmission antennas) in the communication apparatus according to the invention≦the number of reception circuits (reception antennas) in the communication partner such as a base station; and 2≦the number of transmission circuits (transmission antennas) in the communication partner such as a base station≦the number of reception circuits (reception antennas) in the communication apparatus according to the invention.

In the second embodiment (the communication apparatus shown in FIG. 2), the number of systems of transmission circuits allocated for the establishment of the second communication channel and the number of systems of reception circuits allocated for the establishment of the second communication channel are each assumed to be two. Alternatively, of those two numbers, only one may be two (or more). When the number of systems of transmission circuits allocated for the establishment of the second communication channel is one, however, the control signal for handover that is transmitted from the communication apparatus according to the invention is transmitted by an ordinary one-to-one communication scheme different from the MIMO transmission scheme. Likewise, when the number of systems of reception circuits allocated for the establishment of the second communication channel is one, the control signal for handover that is transmitted from a base station (unillustrated) or the like and is received by the communication apparatus according to the invention is transmitted by an ordinary one-to-one communication scheme different from the MIMO transmission scheme.

In the second embodiment (the communication apparatus shown in FIG. 2), the number of systems of transmission circuits allocated for the retaining of the first communication channel and the number of systems of reception circuits allocated for the retaining of the first communication channel are each assumed to be two. Alternatively, of those two numbers, only one may be two (or more). When the number of systems of transmission circuits allocated for the retaining of the first communication channel is one, however, the signal carrying substantive information (the digital data fed in via the conductor 56) that is transmitted from the communication apparatus according to the invention during handover is transmitted by an ordinary one-to-one communication scheme different from the MIMO transmission scheme. Likewise, when the number of systems of reception circuits allocated for the retaining of the first communication channel is one, the information transmitted from a base station (unillustrated) or the like via the first communication channel is transmitted by an ordinary one-to-one communication scheme different from the MIMO transmission scheme.

In illustration of the present invention, the above description deals mainly with wireless communication apparatuses that conduct communication on a wireless basis. Needles to say, the present invention is applicable to communication apparatuses that conduct communication on a wired basis. Moreover, communication apparatuses according to the invention are suitable for use in cellular phones, wireless LANs, and the like.

What is claimed is:

1. A communication apparatus adopting a MIMO transmission scheme and including M systems (where M is an integer equal to or greater than 2) of transmission circuits for transmitting signals individually and N systems (where N is an integer equal to or greater than 2) of reception circuits for receiving signals individually,
the communication apparatus comprising:
a control circuit that, when handover from a first communication channel to a second communication channel takes place during communication of information, allocates part of the M systems of transmission circuits and part of the N systems of reception circuits for establishment of the second communication channel and allocates the rest of the M systems of transmission circuits and of the N systems of reception circuits for retaining of the first communication channel to continue the communication of information.

2. The communication apparatus of claim 1,
wherein, after establishment of the second communication channel, the control circuit allocates all of the M systems of transmission circuits and all of the N systems of reception circuits to the second communication channel.

3. The communication apparatus of claim 1, further comprising:
a first local signal source and a second local signal source each for performing frequency conversion on a to-be-transmitted signal and on a received signal,
wherein, when the handover takes place, the part of the transmission circuits and reception circuits allocated for establishment of the second communication channel perform transmission and reception by sharing the first local signal source and the rest of the transmission circuits and reception circuits allocated for retaining of the first communication channel perform transmission and reception by sharing the second local signal source.

4. The communication apparatus of claim 3,
wherein the communication apparatus conducts communication by a communication scheme that uses different channel frequencies between before and after handover.

5. The communication apparatus of claim 4,
wherein the communication scheme is an FDMA scheme.

6. The communication apparatus of claim 1, further comprising:
a single local signal source for performing frequency conversion on a to-be-transmitted signal and on a received signal,
wherein all of the M systems of transmission circuits and all of the N systems of reception circuits perform transmission and reception by sharing the single local signal source.

7. The communication apparatus of claim 6,
wherein the communication apparatus conducts communication by a communication scheme that uses a same channel frequency between before and after handover.

8. The communication apparatus of claim 7,
wherein the communication scheme is a CDMA or TDMA scheme.

9. The communication apparatus of claim 1,
wherein, when the handover takes place, two or more systems of transmission circuits and two or more systems of reception circuits are allocated for establishment of the second communication channel (provided that M≧3 and N≧3), and communication performed to establish the second communication channel is performed by the MIMO transmission scheme.

10. The communication apparatus of claim 1,
wherein, when the handover takes place, two or more systems of transmission circuits and two or more systems of reception circuits are allocated for retaining of the first communication channel (provided that M≧3 and N≧3), and the communication of information that is continued through retaining of the first communication channel is performed by the MIMO transmission scheme.
